(19) United States
(12) Patent Application Publication
(10) Pub. No.: US 2019/0358927 A1
(43) Pub. Date: Nov. 28, 2019

(54) Multi-function zipper inspection machine and a method for applying a zipper thereon

(71) Applicant: DALIAN ALTMA INDUSTRY CO., LTD., Dalian, Liaoning (CN)

(72) Inventor: Dayong Tian, Dalian, Liaoning (CN)

(21) Appl. No.: 16/476,269

(22) PCT Filed: May 4, 2017
(86) PCT No.: PCT/CN2017/083007

§ 371 Date: Jul. 5, 2019

(30) Foreign Application Priority Data
Apr. 25, 2017 (CN) 201710274313.X

(51) Int. Cl. B31B 70/81; B31B 70/10; B31B 70/14

(52) U.S. Cl. CPC B31B 70/81; B31B 70/14; B31B 70/10

(57) ABSTRACT

A multi-function zipper inspection machine, comprising: an unwinding, a pull-out roller, an first variable frequency motor A, a first swing roller, a first conveying roller A, a dotted hole punching device, a lateral up zipper device, a heat sealing device, a cooling device, a color mark detecting device, a second conveying roller B, a second swing roller, a winder, a second variable frequency motor B; a first potentiometer A and a second potentiometer B are respectively provided above the first swing roller and the second swing roller to transmit up and down swing amplitude data of the first swing roller and the second swing roller respectively to the first variable frequency motor A and the second variable frequency motor B, so as to control speeds of the unwinding and the winding respectively.

### CROSS REFERENCE OF RELATED APPLICATION

This is a U.S. National Stage under 35 U.S.C. 371 of the International Application PCT/CN2017/083007, filed May 04, 2017, which claims priority under 35 U.S.C. 119(a-d) to CN201710274313.X, filed Apr. 25, 2017.

### BACKGROUND OF THE PRESENT INVENTION

### Field of Invention

The present invention relates to an apparatus for fixing a zipper strip to a film, and more particularly to a multi-function zipper inspection machine for laterally fixing a zipper strip to a film with uniform intervals.

### Description of Related Arts

Multiple opening and closing packages allow a part of the bag to be used, and other parts are closed, which brings convenience to the customer and is quickly used by customers. However, there is still no bag being in the production and processing for applying in shaping, filling and sealing on the automatic packaging machine.

### SUMMARY OF THE PRESENT INVENTION

An object of the present invention is to provide a multi-function zipper inspection machine and a method for applying the zipper on the machine.

A technical solution of the present invention is achieved by the solutions as follows. A multi-function zipper inspection machine, comprising: an unwinding (1), a pull-out roller (21), an first variable frequency motor A (15), a first swing roller (4), a first conveying roller A (5), a dotted hole punching device (7), a lateral up zipper device (8), a heat sealing device (9), a cooling device (10), a color mark detecting device (6), a second conveying roller B (12), a second swing roller (11), a winder (13), a second variable frequency motor B (18); a first potentiometer A (19) and a second potentiometer B (20) are respectively provided above the first swing roller (4) and the second swing roller (11) to transmit up and down swing amplitude data of the first swing roller (4) and the second swing roller (11) respectively to the first variable frequency motor A (15) and the second variable frequency motor B (18), so as to control speeds of the unwinding (1) and the winding (13) respectively, the dotted hole punching device (7), the lateral up zipper device (8), the heat sealing device (9), the cooling device (10) and the color mark detecting device (6) are respectively provided between the first conveying roller A (5) and the second conveying roller B (12); wherein the lateral up zipper device (8), the heat sealing device (9) and the cooling device (10) are all connected with a main motor (17).

Preferably, a spread roller (3) is provided between the pull-out roller (21) and the first swing roller (4).

Preferably, a magnetic particle clutch (14) is provided on an end portion of the unwinding (1), a dancing roller (2) is provided between the pull-out roller (21) and the swing roller (4), wherein the dancing roller (2) controls a degree of tightness of the magnetic powder clutch (14) according to a film force detected.

Preferably, a compensation roller (21) is provided behind the first conveying roller A (5), and a proximity switch (16) is provided adjacent to the compensation roller (21) to control a length of a plastic film conveyed between the first conveying roller (5) and the second conveying roller (12).

Preferably, the lateral up zipper device (8) comprises: the lateral up zipper device (8) comprises an ultrasonic device (800), a pulling zipper servo (801), and a cutter servo (802), a sending zipper servo (803) and a hot zipper servo (804) which are provided along a running position of a film; wherein the pulling zipper servo (801) respectively drives a guiding wheel and a conveying wheel via a first belt A (8011) and a second belt B (8023) to convey a zipper, a cutter is provided between the guiding wheel and the conveying wheel, wherein the cutter is connected with the cutter servo (802); the sending zipper servo (803) drives a fixed wheel (8032) via a third belt C (8031), a top portion of a mechanical arm (8035) is connected with the third belt C to reciprocate along a mechanical slideway (8032) under driven of the third belt C (8031), a mechanical hand (8034) is provided on a front end of the mechanical arm (8035) to send the zipper to a hot knife on a side, wherein the hot knife is connected with the hot zipper servo (804).

Preferably, the pulling zipper servo (801) control the first belt A (8011) to drive an upper guide wheel (8013) and a lower guide wheel (8012) to lead the zipper between the upper guide wheel (8013) and the lower guide wheel (8012) out, and simultaneously the pulling zipper servo (801) controls the second belt B (8023) to drive a transfer wheel (8024) to introduce the zipper into a position between an upper conveyor belt (8025) and a lower conveyor belt (8026).

Preferably, the hot knife comprises an upper hot knife (8041) and a lower hot knife (8042); the cutter comprises an upper cutter (8021) and a lower cutter (8022).

Preferably, the multi-function zipper inspection machine adopts a PLC control system to continuously and laterally heat-seal the zipper to a film according to a set program interval.

Furthermore, the present invention provides a method for applying a zipper of the multi-function zipper inspection machine, comprising steps of:

step (1): setting a PLC control system parameter, and passing a coil through an unwinding (1) at a constant speed unwinding; controlling a degree of tightness of the magnetic powder clutch (14) by a dancing roller (2) according to a film force detected, and flattening the film through a spread roller (3) to enter a swing roller (4); when the swing roller (4) reaches an upper limit or a lower limit, transmitting speed data to the first variable frequency motor A (15) to control a speed of the unwinding (1);

step (2): pulling the film out from the swing roller (4) via the first conveying roller A (5), wherein the first conveying roller A (5) is two conveying nip rollers, and the film is conveyed between the two conveying nip rollers, and when the film is conveyed to a proximity switch (16), the proximity switch (16) controls a length of a pull material between the first conveying roller A (5) and the second conveying roller A (12) to control tension of the film; when the film passes through the dotted hole punching device (7), at least one row of easy tear holes are punched horizontally at a set position;

step (3): when the film enters the lateral up zipper device (8), hot pressing both ends of the zipper by the ultrasonic device (800); wherein the zipper servo (801) drives a lower guide wheel (8012) and an upper guide wheel (8013) to introduce a zipper strip into a limit slot between an upper conveyor belt (8025) and a lower conveyor belt (8026) to confirm the length; a cutter servo (802) drives an upper cutter (8021) to match with the lower cutter (8022) to cut a zipper strip confirmed, and then a sending zipper servo (803) drives a mechanical arm (8035) to send the zipper clamped and cut by the mechanical hand (8034) to the hot knife, and finally the hot zipper servo (804) drives the lower hot knife (8042) to match with the upper hot knife (8041) to burn the zipper strip to an inside of the film, and then the zipper strip which is heat-sealed from the lateral zipper device (8) under the traction of the B transport roller (12) is heat-sealed. The device (9) is secondarily heat-sealed and reinforced, and then the temperature of the heat-sealed position is cooled twice by the cooling device (10) to prevent shrinkage deformation of the heat-sealed position;

step (5): conveying the film to a color mark detecting device (6), and the color mark detecting device (6) detects the film color mark for confirming a length of the film after heat sealing and stretching, when the film is transmitted from a second conveying roller (12) to pass through the second swing roller B (11), and the data is transmitted to the second variable frequency motor B (18) through an upper limit and a lower limit of the second potentiometer B (20) above the second swing roller B (11) to control a speed of a winding (13).

The invention has the beneficial effects that the device is automatically heat-sealed by the PLC control system to fix the zipper strip laterally to the set position of the single layer or the multilayer film, and is formed at one time. The heat sealing method can be heat sealed by a hot knife or by an ultrasonic device or the like. Since the conventional bag making machine cannot complete the function of the lateral zipper, the problem can be solved by the lateral zipper device, and the film with the heat-sealed zipper can be directly applied to the automatic packaging machine and the bag making machine, effectively solve processing difficulties and speed up production.

### BRIEF DESCRIPTION OF THE DRAWINGS

FIG. 1 is a schematic view showing an overall structure of a multi-function zipper inspection machine.

FIG. 2 is a schematic perspective view of a lateral up zipper device.

FIG. 3 is a front view of the lateral up zipper assembly.

### DETAILED DESCRIPTION OF THE PREFERRED EMBODIMENT

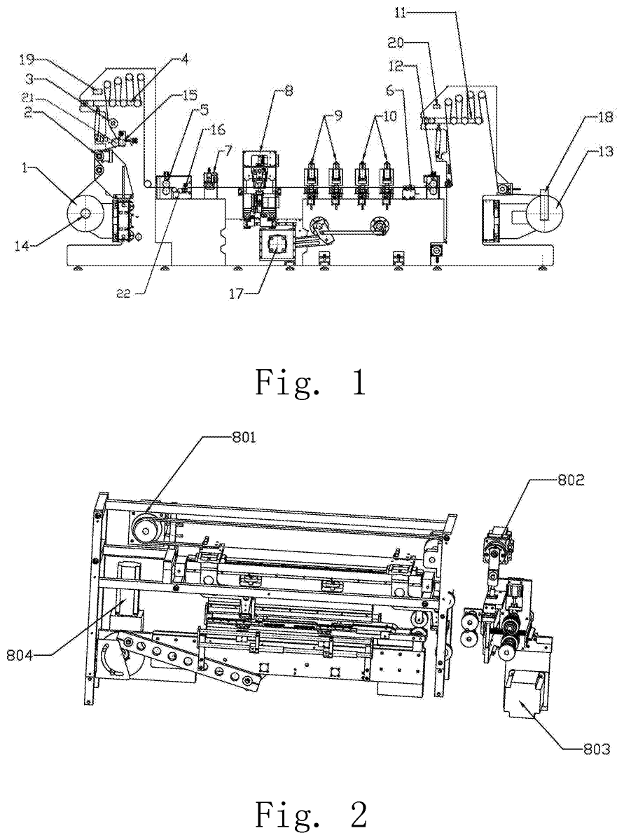

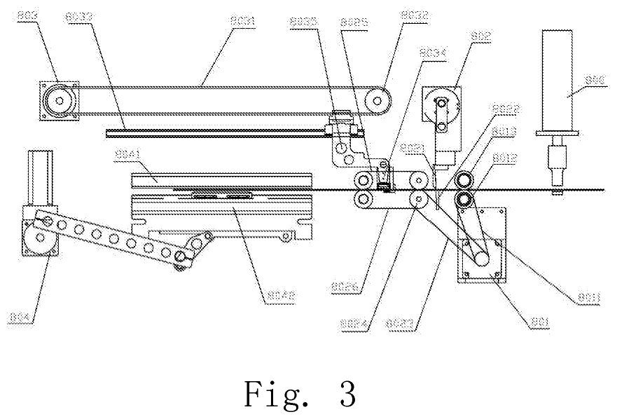

As shown in FIG. 1, a multi-function zipper inspection machine, comprising: an unwinding 1, a pull-out roller 21, an first variable frequency motor A 15, a first swing roller 4, a first conveying roller A 5, a dotted hole punching device 7, a lateral up zipper device 8, a heat sealing device 9, a cooling device 10, a color mark detecting device 6, a second conveying roller B 12, a second swing roller 11, a winder 13, a second variable frequency motor B 18; a first potentiometer A 19 and a second potentiometer B 20 are respectively provided above the first swing roller 4 and the second swing roller 11 to transmit up and down swing amplitude data of the first swing roller 4 and the second swing roller 11 respectively to the first variable frequency motor A 15 and the second variable frequency motor B 18, so as to control speeds of the unwinding 1 and the winding 13 respectively, the dotted hole punching device 7, the lateral up zipper device 8, the heat sealing device 9, the cooling device 10 and the color mark detecting device 6 are respectively provided between the first conveying roller A 5 and the second conveying roller B 12; wherein the lateral up zipper device 8, the heat sealing device 9 and the cooling device 10 are all connected with a main motor 17.

A spread roller 3 is provided between the pull-out roller 21 and the first swing roller 4.

A magnetic particle clutch 14 is provided on an end portion of the unwinding 1, a dancing roller 2 is provided between the pull-out roller 21 and the swing roller 4, wherein the dancing roller 2 controls a degree of tightness of the magnetic powder clutch 14 according to a film force detected.

A compensation roller 21 is provided behind the first conveying roller A 5, and a proximity switch 16 is provided adjacent to the compensation roller 21 to control a length of a plastic film conveyed between the first conveying roller 5 and the second conveying roller 12.

The lateral up zipper device 8 comprises: the lateral up zipper device 8 comprises an ultrasonic device 800, a pulling zipper servo 801, and a cutter servo 802, a sending zipper servo 803 and a hot zipper servo 804 which are provided along a running position of a film; wherein the pulling zipper servo 801 respectively drives a guiding wheel and a conveying wheel via a first belt A 8011 and a second belt B 8023 to convey a zipper, a cutter is provided between the guiding wheel and the conveying wheel, wherein the cutter is connected with the cutter servo 802; the sending zipper servo 803 drives a fixed wheel 8032 via a third belt C 8031, a top portion of a mechanical arm 8035 is connected with the third belt C to reciprocate along a mechanical slideway 8032 under driven of the third belt C 8031, a mechanical hand 8034 is provided on a front end of the mechanical arm 8035 to send the zipper to a hot knife on a side, wherein the hot knife is connected with the hot zipper servo 804.

The pulling zipper servo 801 control the first belt A 8011 to drive an upper guide wheel 8013 and a lower guide wheel 8012 to lead the zipper between the upper guide wheel 8013 and the lower guide wheel 8012 out, and simultaneously the pulling zipper servo 801 controls the second belt B 8023 to drive a transfer wheel 8024 to introduce the zipper into a position between an upper conveyor belt 8025 and a lower conveyor belt 8026.

The hot knife comprises an upper hot knife 8041 and a lower hot knife 8042; the cutter comprises an upper cutter 8021 and a lower cutter 8022.

The multi-function zipper inspection machine adopts a PLC control system to continuously and laterally heat-seal the zipper to a film according to a set program interval.

Furthermore, the present invention provides a method for applying the zipper on the multi-function zipper inspection machine, comprising steps of:

step (1): setting a PLC control system parameter, and passing a coil through an unwinding 1 at a constant speed unwinding; controlling a degree of tightness of the magnetic powder clutch 14 by a dancing roller 2 according to a film force detected, and flattening the film through a spread roller 3 to enter a swing roller 4; when the swing roller 4 reaches an upper limit or a lower limit, transmitting speed data to the first variable frequency motor A 15 to control a speed of the unwinding 1;

step (2): pulling the film out from the swing roller 4 via the first conveying roller A 5, wherein the first conveying roller A 5 is two conveying nip rollers, and the film is conveyed between the two conveying nip rollers, and when the film is conveyed to a proximity switch 16, the proximity switch 16 controls a length of a pull material between the first conveying roller A 5 and the second conveying roller A 12 to control tension of the film; when the film passes through the dotted hole punching device 7, at least one row of easy tear holes are punched horizontally at a set position;

step (3): when the film enters the lateral up zipper device 8, hot pressing both ends of the zipper by the ultrasonic device 800; wherein the zipper servo 801 drives a lower guide wheel 8012 and an upper guide wheel 8013 to introduce a zipper strip into a limit slot between an upper conveyor belt 8025 and a lower conveyor belt 8026 to confirm the length; a cutter servo 802 drives an upper cutter 8021 to match with the lower cutter 8022 to cut a zipper strip confirmed, and then a sending zipper servo 803 drives a mechanical arm 8035 to send the zipper clamped and cut by the mechanical hand 8034 to the hot knife, and finally the hot zipper servo 804 drives the lower hot knife 8042 to match with the upper hot knife 8041 to burn the zipper strip to an inside of the film, and then the zipper strip which is heat-sealed from the lateral zipper device 8 under the traction of the B transport roller 12 is heat-sealed. The device 9 is secondarily heat-sealed and reinforced, and then the temperature of the heat-sealed position is cooled twice by the cooling device 10 to prevent shrinkage deformation of the heat-sealed position;

step 5: conveying the film to a color mark detecting device 6, and the color mark detecting device 6 detects the film color mark for confirming a length of the film after heat sealing and stretching, when the film is transmitted from a second conveying roller 12 to pass through the second swing roller B 11, and the data is transmitted to the second variable frequency motor B 18 through an upper limit and a lower limit of the second potentiometer B 20 above the second swing roller B 11 to control a speed of a winding 13.

1. A multi-function zipper inspection machine, comprising: an unwinding (1), a pull-out roller (21), an first variable frequency motor A (15), a first swing roller (4), a first conveying roller A (5), a dotted hole punching device (7), a lateral up zipper device (8), a heat sealing device (9), a cooling device (10), a color mark detecting device (6), a second conveying roller B (12), a second swing roller (11), a winder (13), a second variable frequency motor B (18); a first potentiometer A (19) and a second potentiometer B (20) are respectively provided above the first swing roller (4) and the second swing roller (11) to transmit up and down swing amplitude data of the first swing roller (4) and the second swing roller (11) respectively to the first variable frequency motor A (15) and the second variable frequency motor B (18), so as to control speeds of the unwinding (1) and the winding (13) respectively, the dotted hole punching device (7), the lateral up zipper device (8), the heat sealing device (9), the cooling device (10) and the color mark detecting device (6) are respectively provided between the first conveying roller A (5) and the second conveying roller B (12); wherein the lateral up zipper device (8), the heat sealing device (9) and the cooling device (10) are all connected with a main motor (17).

2. The multi-function zipper inspection machine, as recited in claim 1, wherein a spread roller (3) is provided between the pull-out roller (21) and the first swing roller (4).

3. The multi-function zipper inspection machine, as recited in claim 1, wherein a magnetic particle clutch (14) is provided on an end portion of the unwinding (1), a dancing roller (2) is provided between the pull-out roller (21) and the swing roller (4), wherein the dancing roller (2) controls a degree of tightness of the magnetic powder clutch (14) according to a film force detected.

4. The multi-function zipper inspection machine, as recited in claim 1, wherein a compensation roller (21) is provided behind the first conveying roller A (5), and a proximity switch (16) is provided adjacent to the compensation roller (21) to control a length of a plastic film conveyed between the first conveying roller (5) and the second conveying roller (12).

5. The multi-function zipper inspection machine, as recited in claim 1, wherein the lateral up zipper device (8) comprises: the lateral up zipper device (8) comprises an ultrasonic device (800), a pulling zipper servo (801), and a cutter servo (802), a sending zipper servo (803) and a hot zipper servo (804) which are provided along a running position of a film; wherein the pulling zipper servo (801) respectively drives a guiding wheel and a conveying wheel via a first belt A (8011) and a second belt B (8023) to convey a zipper, a cutter is provided between the guiding wheel and the conveying wheel, wherein the cutter is connected with the cutter servo (802); the sending zipper servo (803) drives a fixed wheel (8032) via a third belt C (8031), a top portion of a mechanical arm (8035) is connected with the third belt C to reciprocate along a mechanical slideway (8032) under driven of the third belt C (8031), a mechanical hand (8034) is provided on a front end of the mechanical arm (8035) to send the zipper to a hot knife on a side, wherein the hot knife is connected with the hot zipper servo (804).

6. The multi-function zipper inspection machine, as recited in claim 1, wherein the pulling zipper servo (801) control the first belt A (8011) to drive an upper guide wheel (8013) and a lower guide wheel (8012) to lead the zipper between the upper guide wheel (8013) and the lower guide wheel (8012) out, and simultaneously the pulling zipper servo (801) controls the second belt B (8023) to drive a transfer wheel (8024) to introduce the zipper into a position between an upper conveyor belt (8025) and a lower conveyor belt (8026).

7. The multi-function zipper inspection machine, as recited in claim 1, wherein the hot knife comprises an upper hot knife (8041) and a lower hot knife (8042); the cutter comprises an upper cutter (8021) and a lower cutter (8022).

8. The multi-function zipper inspection machine, as recited in claim 1, wherein the multi-function zipper inspection machine adopts a PLC control system to continuously and laterally heat-seal the zipper to a film according to a set program interval.

9. A method for applying the multi-function zipper inspection machine, as recited in claim 1, comprising steps of:
step (1): setting a PLC control system parameter, and passing a coil through an unwinding (1) at a constant speed unwinding; controlling a degree of tightness of the magnetic powder clutch (14) by a dancing roller (2) according to a film force detected, and flattening the film through a spread roller (3) to enter a swing roller (4); when the swing roller (4) reaches an upper limit or a lower limit, transmitting speed data to the first variable frequency motor A (15) to control a speed of the unwinding (1);
step (2): pulling the film out from the swing roller (4) via the first conveying roller A (5), wherein the first conveying roller A (5) is two conveying nip rollers, and the film is conveyed between the two conveying nip rollers, and when the film is conveyed to a proximity switch (16), the proximity switch (16) controls a length of a pull material between the first conveying roller A (5) and the second conveying roller A (12) to control tension of the film; when the film passes through the dotted hole punching device (7), at least one row of easy tear holes are punched horizontally at a set position;
step (3): when the film enters the lateral up zipper device (8), hot pressing both ends of the zipper by the ultrasonic device (800); wherein the zipper servo (801) drives a lower guide wheel (8012) and an upper guide wheel (8013) to introduce a zipper strip into a limit slot between an upper conveyor belt (8025) and a lower conveyor belt (8026) to confirm the length; a cutter servo (802) drives an upper cutter (8021) to match with the lower cutter (8022) to cut a zipper strip confirmed, and then a sending zipper servo (803) drives a mechanical arm (8035) to send the zipper clamped and cut by the mechanical hand (8034) to the hot knife, and finally the hot zipper servo (804) drives the lower hot knife (8042) to match with the upper hot knife (8041) to burn the zipper strip to an inside of the film, and then the zipper strip which is heat-sealed from the lateral zipper device (8) under the traction of the B transport roller (12) is heat-sealed. The device (9) is secondarily heat-sealed and reinforced, and then the temperature of the heat-sealed position is cooled twice by the cooling device (10) to prevent shrinkage deformation of the heat-sealed position;
step (4): conveying the film to a color mark detecting device (6), and the color mark detecting device (6) detects the film color mark for confirming a length of the film after heat sealing and stretching, when the film is transmitted from a second conveying roller (12) to pass through the second swing roller B (11), and the data is transmitted to the second variable frequency motor B (18) through an upper limit and a lower limit of the second potentiometer B (20) above the second swing roller B (11) to control a speed of a winding (13).
